(19) United States
(12) Patent Application Publication
(10) Pub. No.: US 2014/0253627 A1
(43) Pub. Date: Sep. 11, 2014

(54) FLOW PATH UNIT, LIQUID EJECTING HEAD, LIQUID EJECTING APPARATUS, AND MANUFACTURING METHOD OF FLOW PATH SUBSTRATE

(71) Applicant: Seiko Epson Corporation, Tokyo (JP)

(72) Inventor: Hajime Nakao, Azumino (JP)

(73) Assignee: Seiko Epson Corporation, Tokyo (JP)

(21) Appl. No.: 14/190,240

(22) Filed: Feb. 26, 2014

(30) Foreign Application Priority Data
Mar. 11, 2013 (JP) 2013-048332

(51) Int. Cl. B41J 2/17; G01B 11/00

(52) U.S. Cl. CPC B41J 2/17; G01B 11/00
USPC 347/19; 264/40.1

(57) ABSTRACT

A flow path unit includes a light transmitting flow path substrate having a liquid flow path and a coupling substrate connected with the flow path substrate. In the flow path unit, a space as a first positioning mark is provided at the side of a first substrate-surface of the flow path substrate or at the inside of the flow path substrate. Further, a film as a second positioning mark is provided at the side of a second substrate-surface of the flow path substrate that is opposite to the first substrate-surface side. Furthermore, a hole as a third positioning mark is provided in the coupling substrate. The second positioning mark is provided at a position where the first positioning mark is projected.

### BACKGROUND

1. Technical Field

The present invention relates to flow path units, liquid ejecting heads, liquid ejecting apparatuses, and manufacturing methods of flow path substrates.

2. Related Art

As a flow path unit that constitutes a liquid ejecting head such as an ink jet recording head or the like, for example, such an entity is well-known that is made by connecting a flow path substrate and a coupling substrate such as a nozzle plate or the like. The stated flow path substrate is obtained through calcination of a green sheet in which a space for a liquid flow path is formed. The liquid flow path includes, for example, a pressure chamber, a liquid supply path to the pressure chamber, and a communication path extending from the pressure chamber to a nozzle. Liquid such as ink or the like within the pressure chamber is pressurized due to deformation of a vibration plate which is part of a wall of the pressure chamber.

Such flow path unit can be constituted by forming positioning holes in the members forming various flow paths and inserting pins into these positioning holes to laminate and connect the members, for example.

As described in JP-A-2010-142902, an alignment mark or the like is formed on a surface of a main substrate made of Si, an orifice plate is connected to the surface thereof, and an auxiliary substrate with metal formed on a surface of an auxiliary substrate base made of glass is connected to the orifice plate, whereby a laminated entity obtained through the above process and a mask can be appropriately positioned.

In the case where a plurality of members constituting a flow path unit are positioned to each other, the positioning of the members need be carried out so that each flow path is connected precisely to each other. Since nozzle densities have been raised these days, it is required to enhance the precision positioning of the members.

The above-mentioned issue of precision of position adjustment between the flow path substrate and the coupling substrate is present not only in a liquid ejecting head, but also is similarly present in various kinds of flow path units.

### SUMMARY

An advantage of some aspects of the invention is to provide a technique capable of enhancing precision of position adjustment between a flow path substrate and a coupling substrate.

A flow path unit according to an aspect of the invention includes a light transmitting flow path substrate having a liquid flow path and a coupling substrate connected with the flow path substrate. In the flow path unit, there are provided a space as a first positioning mark at the side of a first substrate-surface of the flow path substrate or at the inside of the flow path substrate, a film as a second positioning mark at the side of a second substrate-surface of the flow path substrate that is opposite to the side of the first substrate-surface, and a hole as a third positioning mark in the coupling substrate. Further, the second positioning mark is provided at a position where the first positioning mark is projected.

A liquid ejecting head such as an ink jet head or the like according to an aspect of the invention includes the flow path unit and a nozzle communicating with the liquid flow path.

A liquid ejecting apparatus such as an ink jet printer or the like according to an aspect of the invention includes the above liquid ejecting head.

In the flow path unit according to an aspect of the invention, a plurality of the liquid flow paths are provided in the flow path substrate, the second positioning marks and the third positioning marks are respectively disposed at both sides of the plurality of liquid flow paths, and the flow path substrate and the coupling substrate are connected with each other so that a position of the second positioning mark corresponding to the third positioning mark at one side of both the sides of the plurality of liquid flow paths and a position of the second positioning mark corresponding to the third positioning mark at the other side have a symmetric positional relationship with respect to the plurality of liquid flow paths.

According to the above aspect, the flow path substrate has a light transmitting property and the second positioning marks are provided at the positions where the first positioning marks provided at the first substrate-surface side of the flow path substrate or at the inside of the flow path substrate are projected. Since the third positioning marks are provided in the coupling substrate, it is possible to adjust the positions of the flow path substrate and the coupling substrate using the second positioning marks and the third positioning marks. The second positioning marks of the flow path substrate can be clearly viewed at the time of position adjustment because the second positioning marks are provided at the second substrate-surface side. In addition, because the second positioning marks are provided at the positions where the first positioning marks are projected, it is possible to enhance the precision of position adjustment between the flow path substrate and the coupling substrate.

The liquid flow path may be formed inside the flow path substrate, or may be a groove or the like recessed from a surface of the flow path substrate.

The connection between the flow path substrate and the coupling substrate may be the one with an adhesive interposed therebetween, or may be the one without anything interposed therebetween. It is to be noted that both the connection modes described above are included in the “connection” of the aspects of the invention.

Each of the positioning marks may be formed in a shape of a space or the like that is provided in a substrate (flow path substrate or coupling substrate), or may be a portion formed of a material that differs from that of a substrate base.

In the flow path unit according to an aspect of the invention, the flow path substrate does not have the liquid flow path at a position between the first positioning mark and the second positioning mark. This prevents the light passing between the first and second positioning marks from scattering due to the liquid flow path, thereby making it possible to further enhance the precision of position adjustment between the flow path substrate and the coupling substrate.

In the flow path unit according to an aspect of the invention, the second positioning mark at least contains the same material as that of electrodes provided at the second substrate-surface side of the flow path substrate. This makes it possible to form the electrodes and the second positioning mark concurrently so as to lower the manufacturing costs of the flow path unit.

The electrodes include lower and upper electrodes forming an piezoelectric element, a lead electrode, and the like. The second positioning mark may be formed by exactly the same material as that of the electrodes, or may contain a different material from that of the electrodes.

In the flow path unit according to an aspect of the invention, in the case where the first positioning mark is provided inside the flow path substrate, the flow path substrate may have a communication hole extending from the first positioning mark to the first substrate-surface. According to this aspect, because the first positioning mark, which is linked to the communication hole extending to the first substrate-surface, is provided inside the light transmitting flow path substrate and the second positioning mark is provided at a position where the first positioning mark is projected, it is possible to further enhance the precision of position adjustment between the flow path substrate and the coupling substrate.

A manufacturing method according to an aspect of the invention is a manufacturing method of a light transmitting flow path substrate provided with a liquid flow path and connected with a coupling substrate in which a positioning mark is provided, and includes: forming a first mark in which a first positioning mark is formed at the side of a first substrate-surface of a precursor of a flow path substrate base or at the inside of the precursor; forming the flow path substrate base by heating the precursor; and forming a second mark in which a second positioning mark is formed at the side of a second substrate-surface of the flow path substrate base that is opposite to the side of the first substrate-surface at a position where the first positioning mark is projected.

Furthermore, the invention includes aspects of a manufacturing method of a flow path unit, a manufacturing method of a liquid ejecting head, a manufacturing method of a liquid ejecting apparatus, and the like.

In the manufacturing method of the flow path substrate according to the aforementioned aspect of the invention, the first positioning mark is formed at the first substrate-surface side of the precursor of the flow path substrate base or at the inside of the precursor before the precursor is heated, and the first positioning mark is projected to the second substrate-surface side after the precursor has been heated. Because the second positioning mark formed after the precursor having been heated is located at a position where the first positioning mark formed before the precursor being heated is projected, it is possible to precisely adjust the positions of the flow path substrate and the coupling substrate by using the positioning mark of the coupling substrate and the second positioning mark. Since the second positioning mark is located at the second substrate-surface side, the mark can be viewed clearly at the time of position adjustment. Therefore, according to the aspect of the invention, it is possible to provide a manufacturing method capable of enhancing the precision of position adjustment between the flow path substrate and the coupling substrate.

The heating process of the precursor includes calcination of a green sheet (precursor), heating at a temperature at which the precursor is hardened, heating at a temperature at which a plurality of laminated precursors are jointed, and so on. The formation of the first positioning mark in the precursor and the formation of the flow path in the precursor may be carried out at the same time.

### BRIEF DESCRIPTION OF THE DRAWINGS

The invention will be described with reference to the accompanying drawings, wherein like numbers reference like elements.

FIGS. 1A through 1C are cross-sectional views schematically illustrating an example of a flow path substrate, an example of a coupling substrate, and an example of a flow path unit, respectively; FIG. 1D is a plan view of the flow path unit.

FIG. 2 is an exploded perspective view schematically illustrating an example of a configuration of a liquid ejecting head.

FIG. 3A is a cross-sectional view illustrating an example of the liquid ejecting head when cut along a line IIIA-IIIA in FIG. 2; FIG. 3B is a cross-sectional view illustrating the liquid ejecting head when cut along a line IIIB-IIIB in FIG. 2.

FIGS. 4A through 4C are cross-sectional views illustrating an example of a manufacturing process of a liquid ejecting head.

FIGS. 5A through 5C are cross-sectional views illustrating an example of a manufacturing process of a liquid ejecting head.

FIGS. 6A and 6B are cross-sectional views illustrating an example of a manufacturing process of a liquid ejecting head.

FIGS. 7A and 7B are cross-sectional views illustrating an example of a manufacturing process of a liquid ejecting head.

FIGS. 8A through 8D are plan views illustrating states in which flow path substrates and coupling substrates are connected with each other.

FIG. 9 is a view illustrating an example of a general configuration of a recording apparatus (liquid ejecting apparatus).

FIG. 10 is a cross-sectional view illustrating a variation on position adjustment between a flow path substrate and a coupling substrate.

FIGS. 11A and 11B are cross-sectional views of liquid ejecting heads according to variations.

FIG. 12A is a plan view illustrating an example of a large-sized substrate of flow path substrates; FIG. 12B is a plan view illustrating an example a large-sized substrate of coupling substrates.

### DESCRIPTION OF EXEMPLARY EMBODIMENTS

Hereinafter, an embodiment of the invention will be described. Needless to say, the following embodiment is merely an example of the invention, and not all the features described in the embodiment are necessarily needed to solve the above-mentioned issue.

### 1. EXAMPLES OF OUTLINES OF FLOW PATH UNIT, LIQUID EJECTING HEAD, AND LIQUID EJECTING APPARATUS

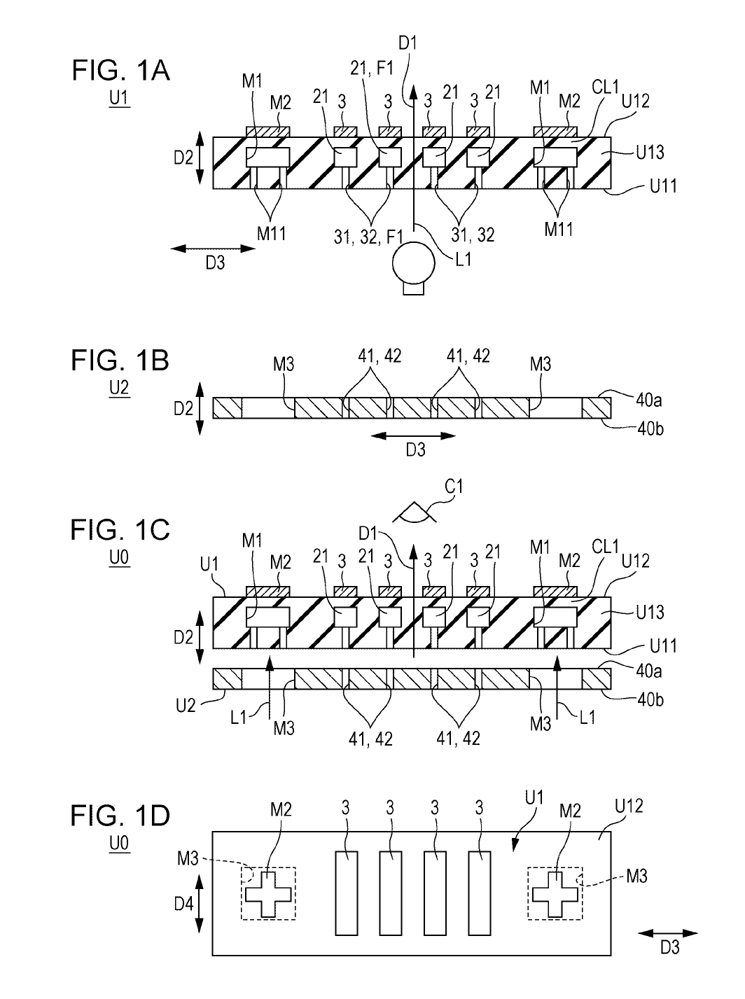

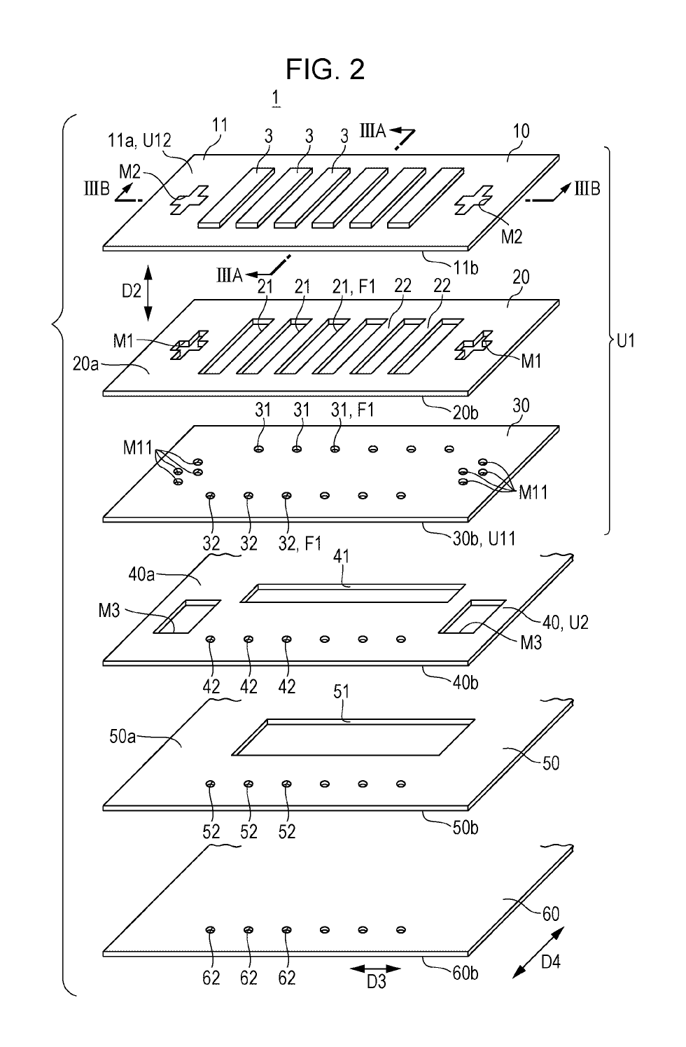

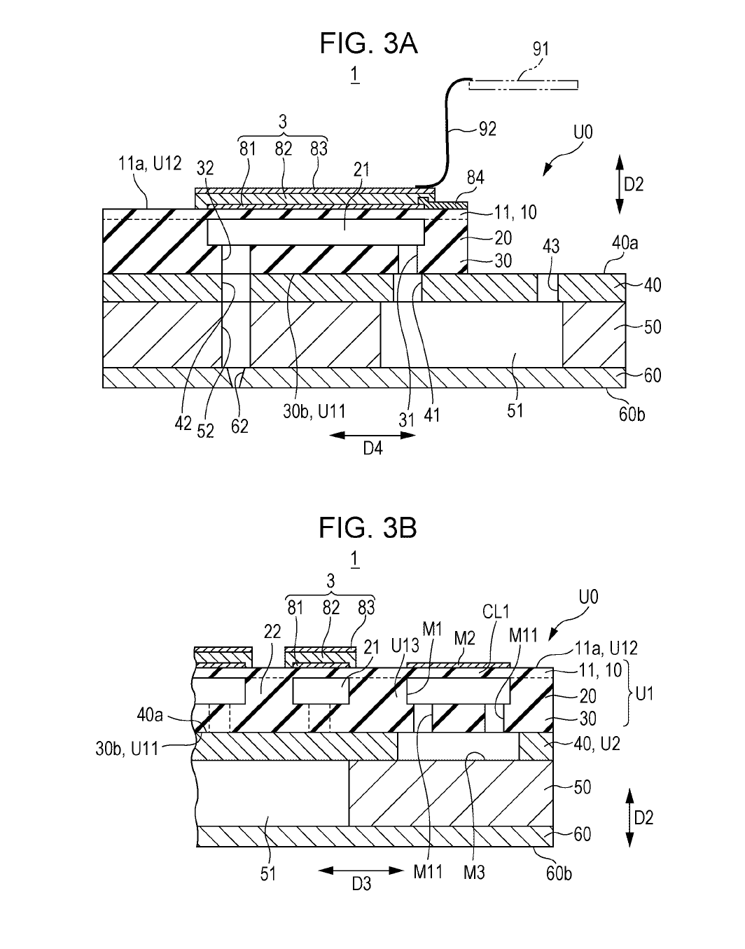

First, examples of a flow path unit, a liquid ejecting head, and a liquid ejecting apparatus will be described. FIG. 1A schematically illustrates an example of a flow path substrate U1, FIG. 1B schematically illustrates an example of a coupling substrate U2, FIG. 1C schematically illustrates an example of a state in which the substrates U1 and U2 are connected, and FIG. 1D illustrates an example of a flow path substrate U1 side of a flow path unit U0. FIG. 2 illustrates an example of a general configuration of a liquid ejecting head 1 including a different flow path unit U0 from that in FIGS. 1C and 1D. FIG. 3A illustrates a cross-sectional view of the liquid ejecting head 1 when cut along the line IIIA-IIIA in FIG. 2, and FIG. 3B illustrates a cross-sectional view of the liquid ejecting head 1 when cut along the line IIIB-IIIB in FIG. 2.

In the drawings mentioned above, a reference symbol D1 indicates a projection direction that light L1 travels, and a reference symbol D2 indicates a thickness direction of the substrates U1 and U2. The projection direction D1 exemplified in FIG. 1A is parallel to the thickness direction D2 and is a direction extending from a pressure chamber 21 toward a vibration plate portion 10. However, the projection direction D1 may not be precisely parallel to the thickness direction D2. A reference symbol D3 indicates a lengthwise direction of the substrates U1 and U2, which is, for example, a direction in which the pressure chambers 21 formed in a long shape are arranged parallel to each other, in other words, a width direction of the pressure chamber 21. A reference symbol D4 indicates a short-length direction of the substrates U1 and U2, which is, for example, a lengthwise direction of the chamber 21. The directions D2, D3 and D4 are orthogonal to each other, however, the directions D2, D3 and D4 may not be orthogonal to each other as long as they intersect with each other. In order to facilitate understanding of the description, the scales of enlargement in the directions D2, D3 and D4 differ from each other in some case, further, the area ratios of piezoelectric elements 3 and marks M1 through M3 to be explained later differ from each other in some case; consequently, the drawings do not dimensionally match each other in some case. Reference numerals 31 and 32 in FIG. 1A denote a liquid supply hole 31 and a nozzle communication hole 32, respectively. Reference numerals 41 and 42 in FIG. 1B and the like denote a liquid common supply hole 41 and a nozzle communication hole 42, respectively.

Positional relationships described in this specification are merely examples for explaining the invention, and are not intended to limit the invention. Accordingly, aside from the configuration in which the flow path substrate is disposed on the upper side of the coupling substrate, such configurations are also included in the invention that the flow path substrate is disposed at the lower side of the coupling substrate, left side thereof, right side thereof, and so on, for example. Further, modifications such as “same”, “orthogonal” and the like with regard to directions, positions and the like are not intended to specify only the exact meanings of “same” and “orthogonal”, and the meanings thereof in this specification also include errors generated during the manufacturing. Furthermore, expressions of “to make contact with something” and “to be connected with/to something” include both the following situations: that is, a situation in which an adhesive or the like is interposed in the interface of the contact or connection, and a situation in which nothing is interposed in the interface of the contact or connection.

The flow path unit U0 illustrated in FIG. 1C and the like includes the light transmitting flow path substrate U1 having a liquid flow path F1 and the coupling substrate U2 connected with the flow path substrate U1. The liquid flow path F1 of the flow path substrate U1 includes the pressure chamber 21, the supply hole 31, and the nozzle communication hole 32. The alignment space (first positioning mark) M1 is provided at the side of a first substrate-surface U11 of the flow path substrate U1 or at an inside U13 of the flow path substrate U1. The alignment mark (second positioning mark) M2 is provided at the side of a second substrate-surface U12 of the flow path substrate U1 that is opposite to the first substrate-surface U11 side. The positioning hole (third positioning mark) M3 is provided in the coupling substrate U2. The alignment mark M2 is provided at a position where the space M1 is projected.

The case in which a mark is provided at the first substrate-surface side or at the second substrate-surface side includes both the following situations: that is, a situation that the mark is exposed on a substrate surface, and a situation that the mark is covered with a different material such as a protection film in the vicinity of the substrate surface.

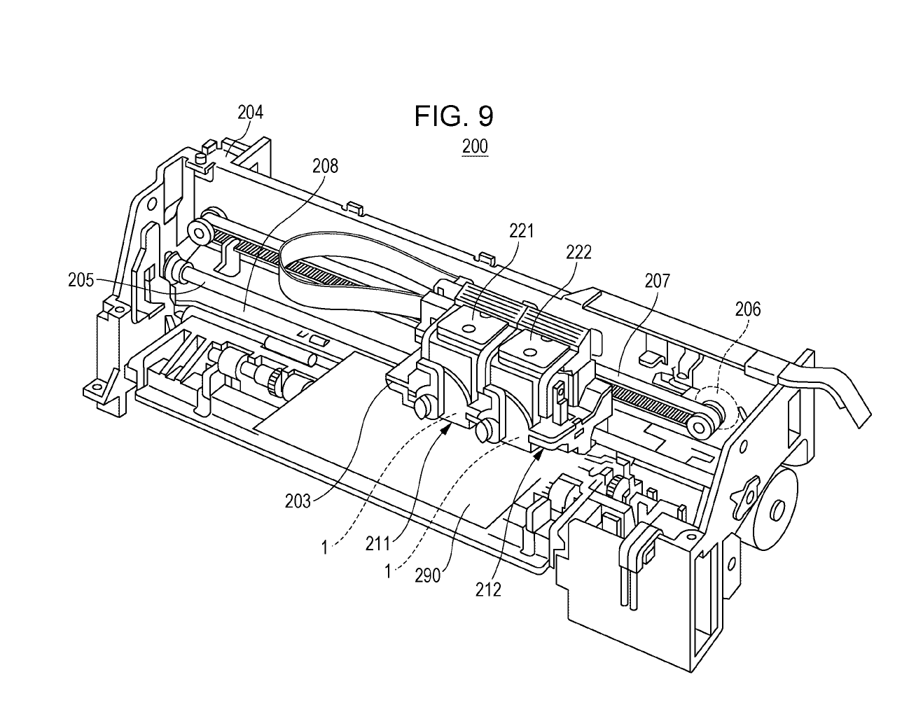

The liquid ejecting head 1 exemplified in FIG. 2 includes the flow path unit U0 and a nozzle 62 communicating with the liquid flow path F1. A recording apparatus (liquid ejecting apparatus) 200 exemplified in FIG. 9 is an ink jet printer having the liquid ejecting head as described above. The following description will be given considering that the liquid ejecting head 1 is an ink jet recording head configured to eject (discharge) ink (liquid).

### 2. DESCRIPTION OF CONSTITUENT ELEMENTS OF LIQUID EJECTING HEAD

The liquid ejecting head 1 shown in FIG. 2 includes the vibration plate portion 10, a spacer 20, a connection portion 30, a sealing plate 40, a reservoir plate 50, and a nozzle plate 60. The flow path substrate U1 of the liquid ejecting head 1 includes the vibration plate portion 10, the spacer 20, and the connection portion 30. The coupling substrate U2 includes the sealing plate 40. The liquid ejecting head 1 need not necessarily include the sealing plate 40 and the reservoir plate 50. For example, in a case of the sealing plate not being included, the reservoir plate can be made to serve as the coupling substrate. In a case of the reservoir plate, in addition to the sealing plate, not being included, the nozzle plate can be made to serve as the coupling substrate. The liquid ejecting head may include an additional plate such as a compliance plate or the like. For example, the compliance plate may be disposed between the reservoir plate and the nozzle plate. Further, these plates may be configured of a plurality of plates, or a single plate may include the functions of a plurality of plates.

The vibration plate portion 10 is a piezoelectric actuator that includes a vibration plate 11, the piezoelectric elements 3, a lead electrode 84, the alignment marks M2, and the like. The vibration plate portion 10 deforms in accordance with driving signals to pressurize liquid within the pressure chamber 21. Electrodes 81, 83 of the piezoelectric element 3 and the lead electrode 84 are the electrodes included in the scope of the aspects of the invention.

The vibration plate 11 seals one surface (front surface 20a) of the spacer 20, while the piezoelectric elements 30, the lead electrode 84, the alignment marks M2, and the like are provided on a front surface 11a (second substrate-surface U12) on the opposite side to a rear surface 11b which is in contact with the spacer 20. The rear surface 11b of the vibration plate constitutes part of a wall of the pressure chamber 21. In other words, the vibration plate 11 as part of the wall of the pressure chamber 21 is caused to deform by the piezoelectric elements in accordance with the driving signals. The vibration plate 11 may or may not have a rectangular plate-like shape. Thickness of the vibration plate can be substantially 0.5 to 10 μm, for example; however, the thickness of the vibration plate is not limited to a specific value as long as the vibration plate exhibits an elastic property.

The piezoelectric element 3 is a pressure generator having a piezoelectric layer 82, the lower electrode (first electrode) 81 provided at a side of the piezoelectric layer facing the pressure chamber 21, and the upper electrode (second electrode) 83 provided at the other side of the piezoelectric layer 82. Each piezoelectric element 3 shown in FIG. 2 is arranged at a position corresponding to each pressure chamber 21. Each lower electrode 81 has a planar shape obtained by projecting each pressure chamber 21 onto the second substrate-surface U12 in the projection direction D1, as shown in FIG. 1C. A control circuit substrate 91 configured to control driving of the piezoelectric element 3 is connected to the upper electrode 83 via, for example, cable members 92 such as a flexible substrate and the like. One of the electrodes 81 and 83 may be a common electrode. The upper and lower electrodes can be constituted by one or more metals including, for example, platinum (Pt), gold (Au), iridium (Ir), titanium (Ti), and so on. Thickness of the upper and lower electrodes, although not specifically limited, can be substantially 10 to 500 nm, for example. As a material of the piezoelectric layer 82, for example, a ferroelectric material such as PZT (lead zirconate titanate, Pb(Zrₓ,Ti₁₋ₓ)O₃), a material having a perovskite structure such as lead-free perovskite type oxide, or the like can be used.

The lead electrode 84 may be connected to the lower electrode 81 or to the upper electrode 83. The lead electrode can be constituted by one or more metals including Au, Pt, aluminum (Al), copper (Cu), nickel (Ni), chromium (Cr), Ti, and so on. Thickness of the lead electrode, although not specifically limited, can be substantially 0.5 to 1.5 μm, for example.

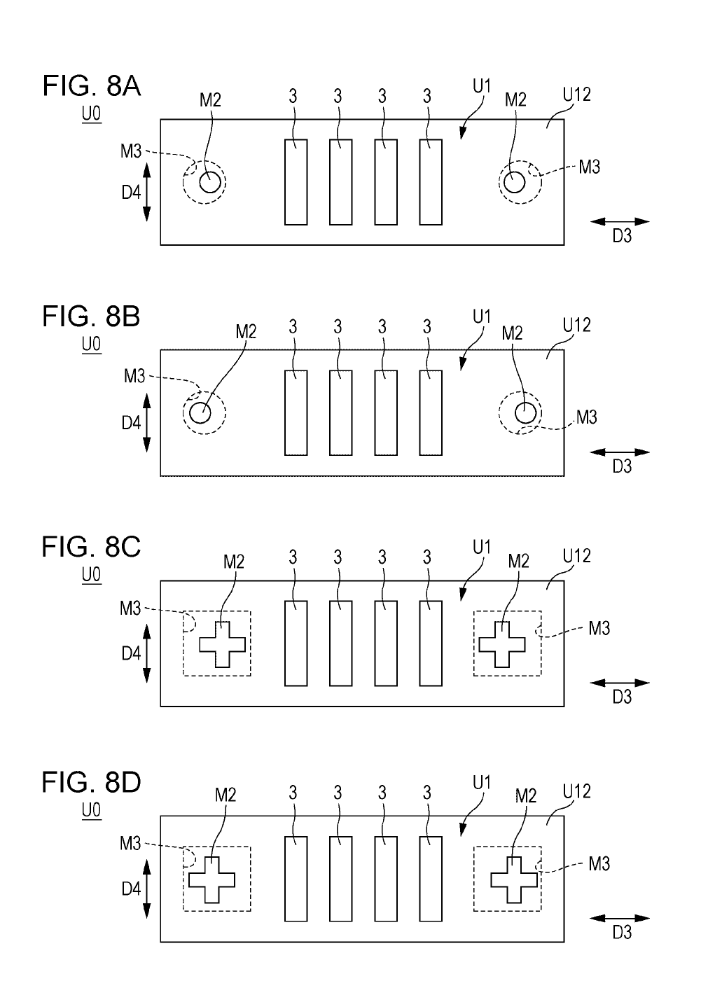

The alignment marks (second positioning marks) M2 formed at the front surface 11a (second substrate-surface U12) side of the vibration plate portion 10 are arranged at the positions corresponding to the respective positioning holes M3 of the sealing plate 40, and provided at both end portions of the flow path substrate in the lengthwise direction D3, that is, provided on the outer sides of the piezoelectric elements 3 in a parallel alignment direction thereof. The alignment mark M2 is smaller in size than the positioning hole M3, as shown in FIG. 1D, and is provided at a position included in the positioning hole M3 when viewed from the thickness direction D2, for example. Needless to say, the alignment mark M2 may be the same in size as the positioning hole or larger than the positioning hole. Further, the alignment marks M2 are arranged at the positions respectively corresponding to the alignment spaces M1 of the spacer 20. As shown in FIG. 1C, the alignment mark M2 has a planar shape obtained by projecting the space M1 onto the second substrate-surface U12 in the projection direction D1. Accordingly, the shape of the alignment mark M2 (second positioning mark) is similar to that of the space M1 (first positioning mark). The alignment mark M2 can take various kinds of shapes such as a cross as shown in FIG. 2, a circle (ellipse) as shown in FIG. 8A, a rectangle (polygon), or the like. The alignment mark M2 may be any mark as long as it can be observed. The mark may take such a shape that is formed in the flow path substrate U1 although it is preferable for the mark to be made of a different material that reflects light or a different material that absorbs light so as to obtain better visibility.

The alignment mark M2 shown in FIG. 3B is formed of the same material as that of the lower electrode 81 which is provided on the front surface 11a of the vibration plate. Needless to say, materials different from that of the lower electrode, such as the materials of the upper electrode, the lead electrode, the protection film and the like, may be laminated on the alignment mark. Moreover, the alignment mark may not contain the material of the lower electrode, but contain the material of the upper electrode, the material of the lead electrode, the material of the protection film, or the like. In the case where the alignment mark M2 is formed of the same material as that of at least one of the electrodes 81, 83 and 84, better visibility of the alignment mark can be obtained. In addition, since the alignment mark and the electrodes can be formed concurrently, it is possible to lower the manufacturing costs of the flow path unit.

In the spacer 20, there are formed the alignment spaces M1 and the pressure chambers 21 passing through the spacer 20 in the thickness direction D2. The spacer 20 is sandwiched between the vibration plate 11 and the connection portion 30 so as to provide the pressure chambers 21 and the spaces M1 at the inside U13 of the flow path substrate U1. The spacer 20 may or may not have a rectangular plate-like shape.

The pressure chambers 21 are formed in a long shape with the lengthwise direction thereof being along the short-length direction D4 of the flow path substrate, and the plurality of pressure chambers 21 are arranged in the lengthwise direction D3 of the flow path substrate. Separation walls 22 are provided between the pressure chambers 21. Pressure is applied to liquid within the pressure chamber 21 due to deformation of the vibration plate 11, which is part of a wall of the chamber. Width and Length of the pressure chamber 21 at the side of the front surface 20a may be the same as those at the side of a rear surface 20b, or the length at the rear surface 20b side may be shorter than that at the front surface 20a side. A plurality of rows, each of which is configured of the pressure chambers 21 aligned in the lengthwise direction D3 of the flow path substrate, may be arranged in the short-length direction D4 of the flow path substrate.

The alignment spaces M1 formed at the inside U13 of the flow path substrate U1 are provided at both the end portions of the flow path substrate in the lengthwise direction D3, that is, provided on the outer sides of the pressure chambers 21 in the parallel alignment direction thereof. For example, as shown in FIG. 2, the space M1 has substantially the same shape as that of the alignment mark M2, and is provided at the same position as that of the alignment mark M2 when viewed from the thickness direction D2. The space M1 can take various kinds of shapes such as a cross, a circle (ellipse), a rectangle (polygon), or the like.

In the connection portion 30, the liquid supply holes 31 and the nozzle communication holes 32 are formed passing through the connection portion 30 in the thickness direction D2 at positions communicating with the pressure chambers 21, and alignment communication holes M11 are also formed passing therethrough in the thickness direction D2 at positions communicating with the respective alignment spaces M1. In other words, the connection portion 30 seals the other surface (rear surface 20b) of the spacer 20 on the opposite side to the front surface 20a while excluding the holes 31, 32 and M11. A rear surface 30b of the connection portion 30 is the first substrate-surface U11 that is connected with a front surface 40a of the sealing plate 40. The connection portion 30 may or may not be formed in a rectangular plate-like shape.

Each of the supply holes 31 is provided at a position corresponding to one end of each of the pressure chambers 21 in the lengthwise direction (D4), while each of the nozzle communication holes 32 is provided at a position corresponding to the other end of each of the pressure chambers 21 in the lengthwise direction (D4). In other words, the liquid flow path F1 including the pressure chamber 21 and the holes 31, 32 is not arranged in a portion between the alignment space M1 and the alignment mark M2 (clearance CL1), and provided at a position not included in the clearance CL1. The communication holes M11 are provided at positions corresponding to four end portions of the space M1 formed in a cross shape. Accordingly, the communication holes M11 are a path extending from the space M1 to the first substrate-surface U11.

One or more light transmitting insulation materials such as ceramics or the like can be used as the materials of the vibration plate 11, spacer 20, and the connection portion 30. The ceramics include, for example, zirconia (ZrOₓ), yttrium oxide (YOₓ), alumina (AlOₓ), and the like.

In the sealing plate 40 (coupling substrate U2), there are formed the liquid common supply hole 41, the nozzle communication holes 42, a liquid introducing hole 43 (see FIG. 3A) to a reservoir 51, and the positioning holes (third positioning marks) M3 passing through the sealing plate 40 in the thickness direction D2. The sealing plate seals one surface (front surface 50a) of the reservoir plate 50 while excluding the holes 41, 42 and 43, and the front surface 40a on the opposite side to a rear surface 40b in contact with the reservoir plate 50 is a connection surface to be connected with the rear surface 30b of the connection portion. The sealing plate 40 may or may not have a rectangular plate-like shape. The rear surface 40b of the sealing plate constitutes part of a wall of the reservoir 51.

The common supply hole 41 is formed in a long shape with the lengthwise direction thereof being along the lengthwise direction D3 of the sealing plate 40, and provided at a position communicating with the plurality of supply holes 31 of the connection portion 30. The nozzle communication holes 42 are provided at positions communicating to the nozzle communication holes 32 of the connection portion 30. The liquid introducing hole 43 is provided at a position that does not make contact with the flow path substrate U1.

The positioning holes M3 are arranged at positions respectively corresponding to the alignment marks M2 provided at the front surface 11a side of the vibration plate, and provided at both end sides of the sealing plate in the lengthwise direction D3, that is, provided on the outer sides of a row of the nozzle communication holes 42. The positioning hole M3 can take various kinds of shapes such as a rectangle (polygon) as shown in FIG. 2, a circle (ellipse) as shown in FIG. 8A, or the like.

The third positioning mark may be a recess from the surface not passing through the plate, may be formed of a different material, or the like, aside from a through-hole like the positioning hole M3. If the third positioning mark is provided at least on the flow path substrate U1 side of the coupling substrate U2, the positions of the substrates can be adjusted with ease while looking from the flow path substrate U1 side.

In the reservoir plate 50, there are formed the reservoir 51 and nozzle communication holes 52 passing through the plate in the thickness direction D2. The reservoir 51 is a common ink chamber communicating with the common supply hole 41 and the liquid introducing hole 43. The nozzle communication holes 52 are provided at positions respectively corresponding to the nozzle communication holes 42 of the sealing plate 40.

In the nozzle plate 60, the nozzles 62 are formed passing through the plate in the thickness direction D2 at positions communicating with the nozzle communication holes 52. In other words, the nozzle plate 60 seals the other surface (rear surface 50b) of the reservoir plate 50 on the opposite side to the front surface 50a while excluding the nozzles 62. The rear surface of the nozzle plate 60 is a nozzle surface 60b where liquid droplets are ejected through the nozzles 62. The nozzle plate 60 shown in FIG. 2 has a nozzle row in which the nozzles 62 communicating with the respective pressure chambers 21 are arranged at a predetermined interval in a predetermined direction (D3). The plurality of nozzles 62 may be disposed in a zigzag pattern.

As the materials of various types of plates including the above-mentioned plates 40, 50 and 60, one or more materials can be used selected from among, for example, metals such as stainless steel and nickel, synthetic resin, ceramics, and the like.

In the liquid ejecting head 1 described above, liquid such as ink or the like is introduced through the liquid introducing hole 43 to fill the reservoir 51, then passes through the common supply hole 41 and the respective supply holes 31 so as to fill the pressure chambers 21. When the piezoelectric element 3 deforms in accordance with a driving voltage (driving signal) from the control circuit substrate 91 to cause the vibration plate 11 to expand toward the pressure chamber 21 side, pressure in the liquid within the pressure chamber 21 is raised due to the deformation of the vibration plate 11 so as to eject a liquid droplet through the nozzle 62 via the nozzle communication holes 32, 42 and 52.

### 3. EXAMPLE OF MANUFACTURING METHOD OF LIQUID EJECTING HEAD INCLUDING FLOW PATH UNIT

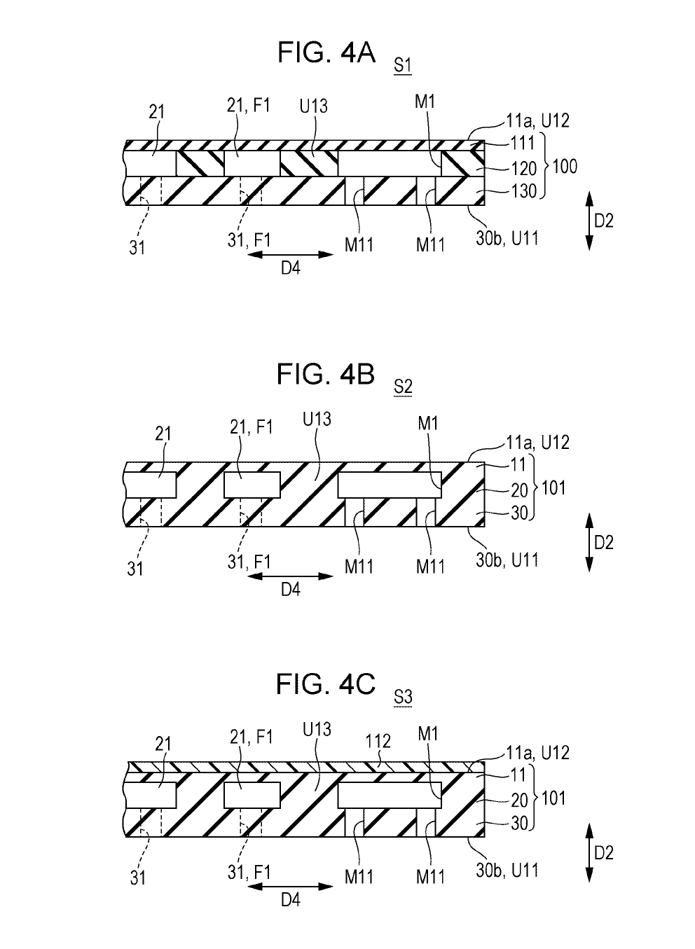

An example of a manufacturing method of the liquid ejecting head with reference to FIGS. 4A through 8D as well as FIGS. 1A through 3B is illustrated. FIGS. 4A through 7B are vertical cross-sectional views along the short-length direction 4D of the flow path substrate exemplifying the alignment space M1 and its periphery.

First, green sheets having a desired thickness are formed from, for example, paste including ceramic powder such as zirconia, binder, and a solvent. A general apparatus such as a doctor blade apparatus, a reverse roll coater apparatus, or the like can be used to form the green sheets. Machine work such as cutting, machining, punching and the like and laser beam machining are performed on the green sheet to be used for the spacer 20 and the green sheet to be used for the connection portion 30. Through this, a sheet-like spacer precursor 120 having the pressure chambers 21 and the alignment spaces M1 is obtained, and a sheet-like connection portion precursor 130 having the holes 31, 32 and M11 is obtained. Any processing is not performed on the green sheet to be used for the vibration plate 11 if not needed. A precursor 100 as shown in FIG. 4A is obtained by laminating a vibration plate precursor 111, the spacer precursor 120, and the connection portion precursor 130 having been obtained. The space M1 is formed at the inside U13 of the precursor 100.

Above described is a first mark formation process S1 in which the first positioning marks M1 are formed inside the precursor.

Next, the overall precursor 100 is calcined to form a flow path substrate base 101 that does not have the alignment mark M2 as shown in FIG. 4B (heating process S2). The flow path substrate base 101 is a section in which the constituent elements on the vibration plate 11 are removed from the flow path substrate U1. A temperature of calcination is not limited to a specific temperature, and any temperature can be employed as the calcination temperature as long as the overall flow path substrate base made of ceramics can be formed. For example, the calcination temperature can be approximately 1,300 to 1,500° C. The precursor 100 may be degreased by being heated at a degreasing temperature which is lower than the calcination temperature before the calcination. Further, the precursor may be dried by being heated at a drying temperature which is lower than the degreasing temperature before the degreasing. The flow path substrate base 101 obtained in the above manner can have sealing properties on superposition surfaces of the vibration plate 11, spacer 20, and connection portion 30 without performing any particular adhesion processing or the like.

The flow path substrate base may be formed by a gel-cast method or the like that uses slurry including ceramic powder, binder and a solvent.

In the case where the flow path substrate base 101 is formed by heating the precursor 100, the material thereof contracts as shown in FIG. 4B. Accordingly, the position of the liquid flow path F1 and the position of the alignment space M1 in the flow path substrate base 101 are determined in accordance with thermal contraction of the material. Because the contraction rate of the precursor 100 slightly varies depending on the heating, the position of the liquid flow path F1 slightly varies among the flow path substrates. In the case where the substrates U1 and U2 including the liquid flow paths are connected with each other, even a small deviation in position of the liquid flow paths causes a drop in yield of flow path unit products. Therefore, in order to enhance the precision of position adjustment between the substrates U1 and U2 while considering the variation in contraction due to the heating, the alignment mark M2 is formed by use of the space M1 that takes a position in accordance with the thermal contraction.

After the formation of the flow path substrate base, a resist film 112 is formed covering the entirety of the vibration plate front surface 11a (second substrate-surface U12) first, as shown in FIG. 4C (resist film formation process S3). A negative-type photosensitive film whose solubility with respect to a developing solution drops when exposed to light, can be used as the resist film 112, for example.

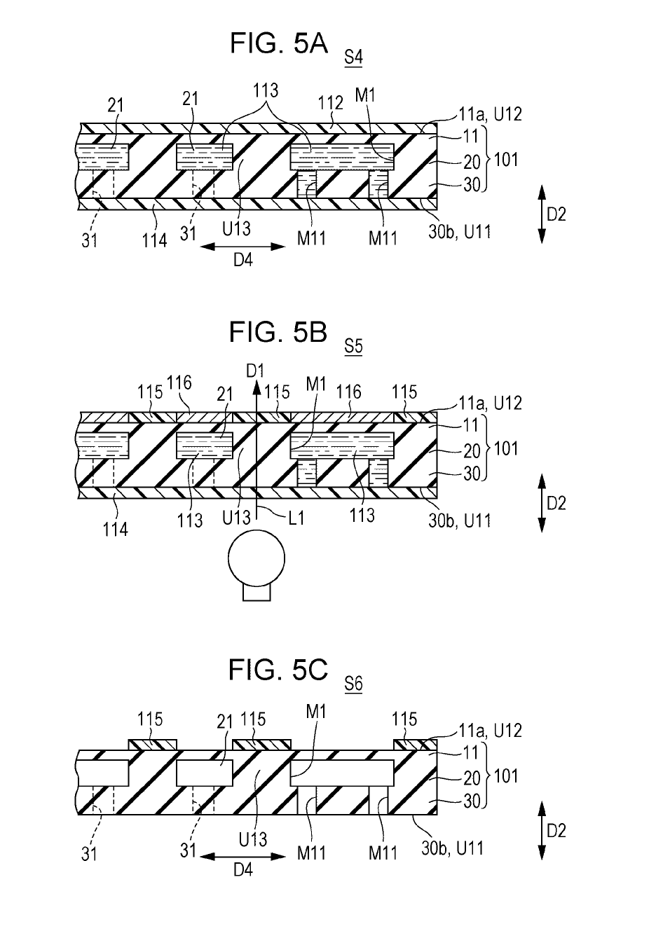

After the formation of the resist film, the pressure chamber 21 and the alignment space M1 are filled with a light blocking liquid (light blocking agent) 113 and a light transmitting seal 114 is provided on the connection portion rear surface 30b (first substrate-surface U11), as shown in FIG. 5A (light blocking agent filling process S4). As the light blocking liquid, for example, a suspension in which fine particles that absorb light are dispersed, or the like can be used. A light transmitting synthetic resin film or the like can be used as the seal 114. The seal 114 may not cover the entirety of the first substrate-surface U11, and may be provided only in the areas corresponding to the holes 31, 32 and M11 so as to seal the holes 31, 32, M11, and so on.

After the filling of the light blocking liquid, the light L1 from a light source is emitted from the connection portion rear surface 30b side so as to expose the resist film 112 to the light at a portion where the light L1 passes through the flow path substrate base 101 in the projection direction D1, as shown in FIG. 5B (exposure process S5). The light L1 is a parallel beam of light, and it is preferable for the projection direction D1 to be along the thickness direction D2 because the piezoelectric element 3 is formed on the upper side of the pressure chamber 21. Through the exposure process S5, the resist film 112 at planar areas where the pressure chamber 21 and the alignment space M1 provided at the inside U13 of the flow path substrate base are projected onto the second substrate-surface U12 in the projection direction D1, is not exposed to the light and becomes unexposed areas 116, while the resist film 112 at planar areas outside the unexposed areas 116 is exposed to the light to become exposed areas 115. Through this, planar latent images obtained by projecting the pressure chamber 21 and the space M1 onto the second substrate-surface U12 in the thickness direction D2, are drawn on the resist film 112. Here, in the flow path substrate base 101, since the space M1 is provided at the inside U13, not at the first substrate-surface U11 side, a portion between the second substrate-surface U12 and the space M1 is narrowed. Accordingly, in this manufacturing method, a planar shape of the space M1 can be projected onto the second substrate-surface U12 more precisely in comparison with a case in which the space M1 is provided at the first substrate-surface U11 side.

A positive-type photosensitive film may be used as the resist film.

After the exposure, the unexposed areas 116 are removed by developing processing, the exposed areas 115 are baked by further emission of the light L1 from the connection portion rear surface 30b side, then the seal 114 is removed from the first substrate-surface U11 so as to remove the light blocking liquid 113 from the pressure chamber 21 and the alignment space M1, as shown in FIG. 5C (resist pattern formation process S6). A resist pattern having a planar shape obtained by projecting the pressure chamber 21 and the space M1 onto the second substrate-surface U12, is formed by the remaining exposed areas 115.

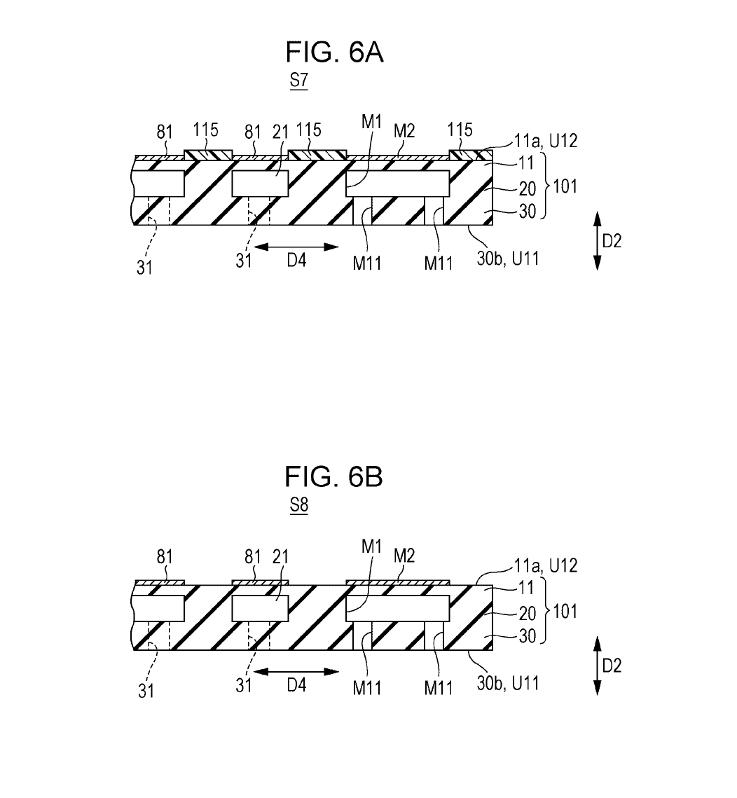

After the resist pattern formation, the lower electrode 81 and the alignment mark M2 are formed simultaneously on the vibration plate 11, as shown in FIG. 6A (first electrode formation process S7). That is to say, the alignment mark M2 is formed by the same material as that of the lower electrode 81, and formed with substantially the same thickness as that of the lower electrode 81. The lower electrode may be formed on the exposed areas 115 because the exposed areas 115 are removed later. The lower electrode may be formed with a gas-phase method such as sputtering, a method that heats a coated film formed by a liquid-phase method such as a spin coat method, or the like.

After the lower electrode formation, as shown in FIG. 6B, the resist pattern (exposed areas 115) is removed, then the lead electrode 84 (see FIG. 3A), which is connected to the lower electrode 81 as needed, is formed on the vibration plate 11 (resist pattern removal process S8). With this, the lower electrode 81 having a planar shape obtained by projecting the pressure chamber 21 onto the second substrate-surface U12 and the alignment mark M2 having a planar shape obtained by projecting the alignment space M1 onto the second substrate-surface U12 are formed at the same time. The removal of the exposed areas 115 can be carried out by a chemical solution method or the like.

The above-described processes S3 through S8 correspond to a second mark formation process in which the second positioning mark is formed at a position where the first positioning mark is projected to the second substrate-surface side of the flow path substrate base.

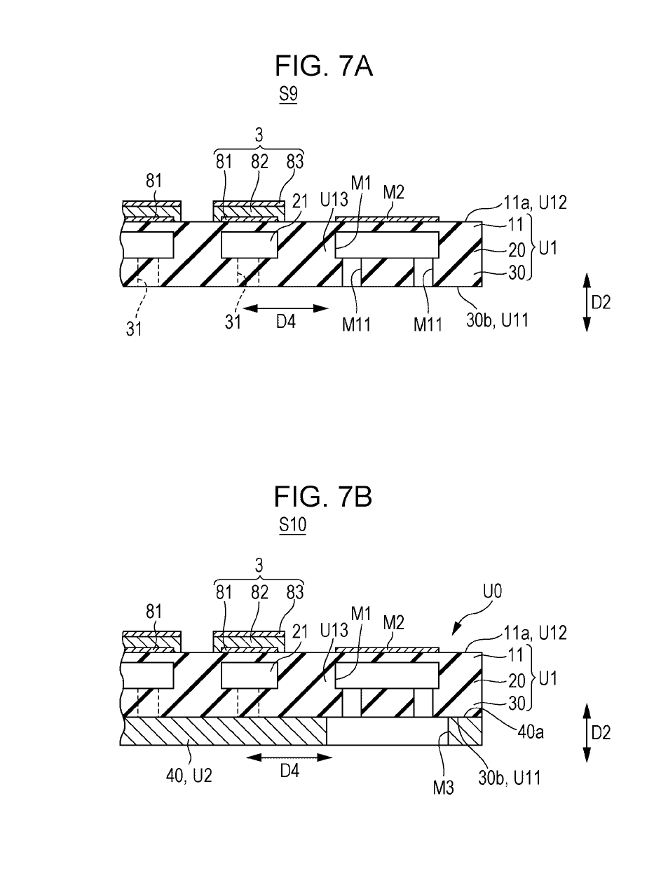

After the removal of the exposed areas, the piezoelectric layer 82 is formed at least on the lower electrode 81, then the upper electrode 83 is formed on the piezoelectric layer 82, as shown in FIG. 7A (piezoelectric element formation process S9). The piezoelectric layer and the upper electrode may be also formed on the alignment mark M2 or the like. In the case where the piezoelectric layer is formed with a liquid-phase method such as a spin coat method, it is sufficient that a set of following examples of processing is repeated a plurality of times: that is, application processing of a precursor solution in which metallic organic matter constituting PZT is dispersed in a dispersion medium; drying processing at approximately 170 to 180° C.; degreasing processing at approximately 300 to 400° C.; and calcination processing at approximately 550 to 800° C. Alternatively, the piezoelectric layer may be formed with a gas-phase method such as sputtering. The upper electrode may be also formed with a gas-phase method such as sputtering, a method that heats a coated film formed by a liquid-phase method, or the like. Unnecessary portions in the piezoelectric layer and the upper electrode may be removed by patterning. Meanwhile, the resist pattern may be formed on the flow path substrate base prior to the formation of the piezoelectric layer, then the piezoelectric layer and the upper electrode may be formed on the entirety of the flow path substrate, thereafter the piezoelectric layer and the upper electrode may be removed together with the resist pattern.

The flow path substrate U1 is formed by the processes described above, subsequently the flow path substrate U1 and the sealing plate 40 (coupling substrate U2) are connected with each other as shown in FIG. 7B (flow path substrate connection process S10). At this time, for example, as shown in FIG. 1C, light is emitted from the coupling substrate U2 side, and an image acquisition device C1 such as a camera observes the second substrate-surface U12 of the flow path substrate U1 to make the alignment mark M2 of the flow path substrate match the positioning hole M3 of the coupling substrate. The light L1 emitted from the coupling substrate U2 side passes through the positioning hole M3, passes through the base portion of the light transmitting flow path substrate U1 (connection portion 30, spacer 20, vibration plate 11), and is blocked by the alignment mark M2. Accordingly, as shown in FIG. 1D, an observed image by the image acquisition device C1 is brighter at a portion corresponding to the positioning hole M3 and a shadow of the alignment mark M2 can be viewed at the stated portion. A planar shape of the positioning hole M3 provided at the rear side of the flow path substrate U1 is blurred to some extent because the light L1 passes through the flow path substrate U1. However, the alignment mark M2 is clearly viewed because the mark is provided at the front surface (second substrate-surface U12) side of the flow path substrate U1. Moreover, because the liquid flow path F1 is not disposed between the alignment space M1 and the alignment mark M2, light passing through the positioning hole M3 and then passing through the flow path substrate U1 is not caused to scatter by the flow path substrate U1. Accordingly, this technique makes it possible to precisely perform position adjustment between the substrates U1 and U2.

As described earlier, because the contraction rate of material slightly varies when the flow path substrate U1 is formed by heating the precursors 100, it is not always the case that the alignment mark M2 and the positioning hole M3 completely match each other in every combination of the alignment marks M2 and the positioning holes M3. FIGS. 8A through 8D schematically exemplify the states in which the substrates U1 and U2 are connected with each other while matching the marks (M2, M3) of various shapes.

FIGS. 8A and 8B illustrate observed images in the case where the flow path substrate U1 and the coupling substrate U2 are connected with each other while matching the marks (M2, M3) of circular shapes. Meanwhile, FIGS. 8C and 8D illustrate observed images in the case where the substrates U1 and U2 are connected with each other while matching the alignment marks M2 of a cross shape and the positioning holes M3 of a rectangular shape.

Note that the contraction rate of the flow path substrates U1 shown in FIGS. 8A and 8C is larger; therefore, a distance between the centers of the alignment marks M2 is shorter than a distance between the centers of the positioning holes M3. In this case, by equally shifting the respective alignment marks M2 toward inner sides in the lengthwise direction D3 with respect to the positioning holes M3, it is possible to precisely perform the position adjustment and connect the substrates U1 and U2 with each other. On the other hand, as shown in FIGS. 8B and 8D, the contraction rate of the flow path substrates U1 is smaller so that a distance between the centers of the alignment marks M2 is longer than a distance between the centers of the positioning holes M3 in some case. In this case, by equally shifting the respective alignment marks M2 toward outer sides in the lengthwise direction D3 with respect to the positioning holes M3, the position adjustment can be performed with precision.

In the case where the substrates U1 and U2 are connected with each other via a thermocompression bonding adhesive sheet having a rectangular shape as large as the flow path substrate U1, an adhesive sheet in which there are formed holes having substantially the same shapes as those of the holes 41, 42 and holes having substantially the same shapes as those of the positioning holes M3, can be used. In this case, it is sufficient that the above position adjustment is performed with the adhesive sheet being sandwiched between the substrates U1 and U2, thereafter the substrates U1 and U2 are bonded thermocompressively to each other. In the obtained flow path unit, the substrates U1 and U2 are connected with each other via the adhesive sheet.

If the adhesive is not a type of adhesive used for thermocompression bonding, heating is not necessary and the connection is carried out in accordance with the given adhesive. For example, in the case where a liquid adhesive is applied to the first substrate-surface U11 of the flow path substrate U1 or to the front surface of the coupling substrate U2, it is sufficient that the above position adjustment is performed after the adhesive is applied and before the applied adhesive hardens.

In the case where at least one of the substrates U1 and U2 is thermocompressively bondable (self-adhesive), it is sufficient that the substrates U1 and U2 are bonded thermocompressively to each other without using an adhesive or the like while performing the position adjustment.

After the connection of the flow path substrate U1 and the sealing plate 40 (coupling substrate U2), it is sufficient that the reservoir plate 50 as well as the nozzle plate 60 are connected to the flow path unit U0 and the control circuit substrate 91 is connected to the electrode with the cable members 92 (head formation process). The connection of the control circuit substrate 91 may be carried out before the flow path substrate U1 and the sealing plate 40 are connected with each other. The reservoir plate 50 and the nozzle plate 60 may be connected with each other beforehand. In this case, a laminated entity of the plates 50 and 60 is connected to the flow path unit U0. Needless to say, the nozzle plate 60, the reservoir plate 50, and the flow path unit U0 may be laminated in sequence and connected with each other at the same time. As described above, the connection between the plates can be carried out with a method using an adhesive sheet, a method using a liquid adhesive, a method using a self-adhesive plate, or the like.

In the manner described above, the liquid ejecting head 1 as illustrated in FIGS. 3A and 3B is manufactured.

If a positioning hole is formed in the reservoir plate 50, it is possible to laminate the reservoir plate 50, the sealing plate 40, and the flow path substrate U1 in sequence and perform the above-described position adjustment. Further, if a positioning hole is formed in the nozzle plate 60, it is possible to laminate the plates 60, 50, 40 and the flow path substrate U1 in sequence and perform the above position adjustment.

According to this manufacturing method, the alignment mark (second positioning mark) M2 is formed at the second substrate-surface U12 side of the light transmitting flow path substrate U1 at a position where the alignment space (first positioning mark) M1 is projected. Since the positioning hole (third positioning mark) M3 is formed in the coupling substrate U2, the positions of the substrates U1 and U2 can be adjusted using the alignment mark M2 and the positioning hole M3. Since the alignment mark M2 is provided at the position where the space (first positioning mark) M1 formed in the precursor 100 of the flow path substrate is projected, the alignment mark M2 is a positioning mark in which the deviation in position caused by a slight variation in the contraction rate at the time of forming the flow path substrate by heating the precursor is reflected. Further, because the alignment mark M2 is arranged at the second substrate-surface U12 side of the flow path substrate, the alignment mark M2 is clearly viewed and the visibility of the alignment mark M2 is enhanced. Therefore, the precision of position adjustment between the flow path substrate and the coupling substrate can be enhanced.

### 4. EXAMPLE OF LIQUID EJECTING APPARATUS

FIG. 9 illustrates an external view of an ink jet recording apparatus (liquid ejecting apparatus) 200 including the above-described liquid ejecting heads 1 as recording heads. The recording apparatus 200 can be manufactured by installing the liquid ejecting heads 1 into recording head units 211 and 212, respectively. In the recording apparatus 200 shown in FIG. 9, the recording head units 211 and 212 respectively have the liquid ejecting heads 1, and ink cartridges 221, 222 serving as external ink supply units are provided in a detachable manner. A carriage 203 on which the recording heads 211 and 212 are mounted is so provided as to move back and forth along a carriage shaft 205 attached to an apparatus main body 204. When the driving force of a driving motor 206 is transmitted to the carriage 203 via a plurality of gears (not shown) and a timing belt 207, the carriage 203 is moved along the carriage shaft 205. A recording sheet 290 fed by a paper feed roller (not shown) or the like is transported onto a platen 208, and printing is performed using ink droplets supplied from the ink cartridges 221, 222 and ejected from the liquid ejecting heads 1.

### 5. APPLICATIONS AND OTHERS

Various kinds of variations can be made on this invention.

For example, the recording apparatus may be a so-called line head printer in which the liquid ejecting head is fixed in an unmovable manner and printing is performed only by moving recording sheets.

Liquid discharged from a liquid ejecting head may be any material as long as it can be discharged from the liquid ejecting head, and includes fluids such as a solution in which a dye or the like is dissolved in a solvent, sol in which solid particles such as pigment or metal particles are dispersed in a dispersion medium, and the like. The stated fluids include ink, liquid crystal, and so on. The liquid ejecting head can be mounted on, in addition to an image recording apparatus such as a printer, a manufacturing apparatus of filters for liquid crystal displays or the like, a manufacturing apparatus of electrodes for organic EL displays, field emission displays (FEDs) or the like, a biochip manufacturing apparatus, and so on.

The piezoelectric element for applying pressure to the pressure chamber is not limited to a thin film type as shown in FIGS. 3A and 3B, and may be a laminated type in which piezoelectric materials and electrode materials are alternately laminated, a longitudinal vibration type which longitudinally vibrates to give a pressure change to the pressure chamber, or the like. The piezoelectric actuator may be an actuator that ejects liquid droplets through nozzles using air bubbles generated by the heat of a heating element, a so-called electrostatic actuator that ejects liquid droplets through nozzles by deforming a vibration plate using static electricity generated between the vibration plate and the electrode, or the like. Further, the above piezoelectric elements and piezoelectric actuators can be applied to other various flow path units.

Various methods can be cited for the position adjustment between the substrates U1 and U2.

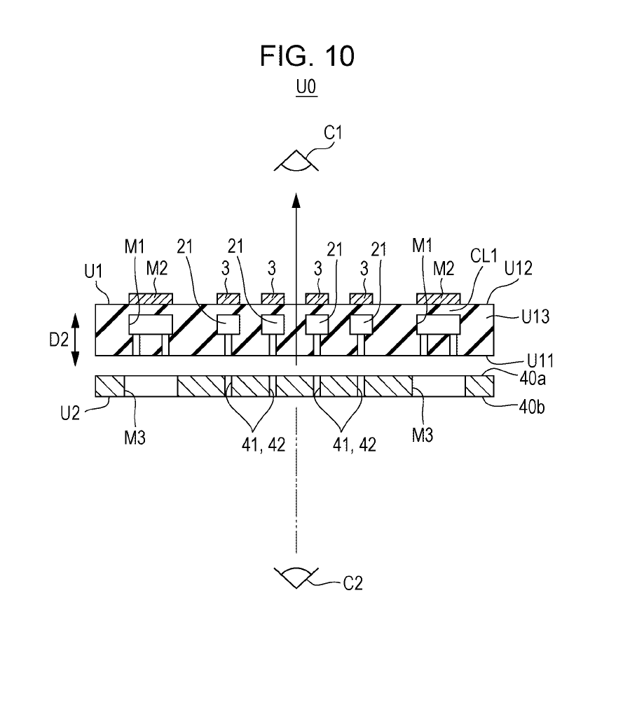

For example, as shown in FIG. 10, in addition to the image acquisition device C1 provided on the flow path substrate U1 side, another image acquisition device C2 is provided on the coupling substrate U2 side so that the position adjustment may be performed while comparing the images acquired by the image acquisition devices C1 and C2. In this case, even a slight positional deviation between the image acquisition devices C1 and C2 can cause an error in the position adjustment between the substrates U1 and U2. However, because the positioning hole M3 can be clearly viewed, it is possible to perform the position adjustment between the substrates with precision.

Using only the image acquisition device C1 on the flow path substrate U1 side, relative positions of the substrate U2 and the image acquisition device C1 may be fixed first without presence of the flow path substrate U1, then the image acquisition device C1 may acquire an image of the substrate U2. Thereafter, the image acquisition device C1 may acquire an image of the substrate U1 while the substrate U1 being moved relative to the substrate U2 and the image acquisition device C1. The position adjustment between the substrates may be performed while comparing the positioning hole M3 in the image of the substrate U2 with the alignment mark M2 in the image of the substrate U1. Through this, the position adjustment between the substrates can be performed with precision.

Further, the coupling substrate U2 may not be connected to the first substrate-surface U11, but to the second substrate-surface U12.

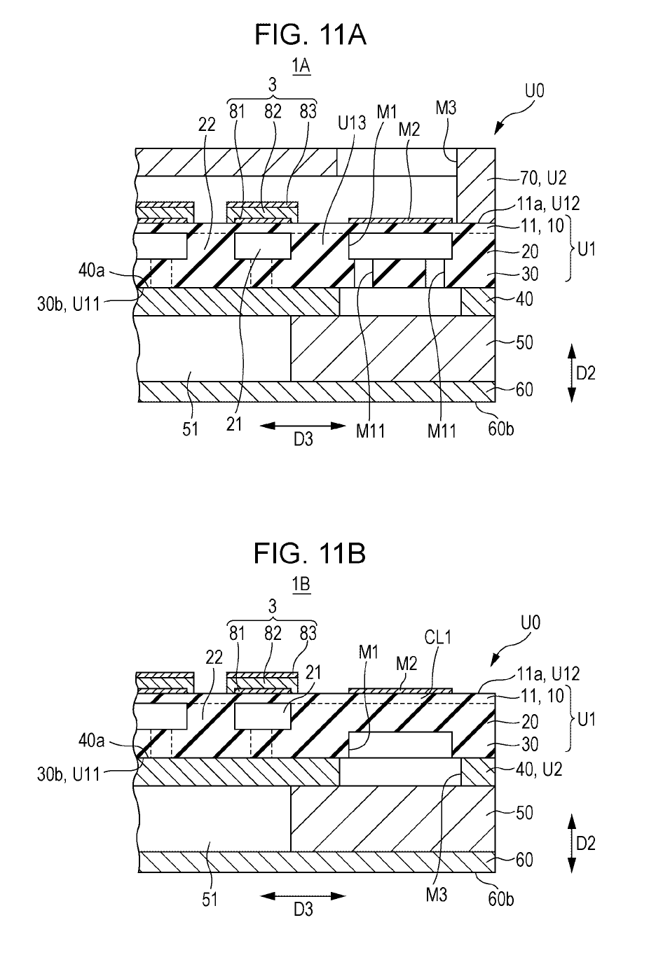

FIG. 11A illustrates a liquid ejecting head 1A in which the coupling substrate U2 is also provided on the second substrate-surface U12. In the liquid ejecting head 1A, a protection substrate 70 to serve as the coupling substrate U2 is connected to the second substrate-surface U12 of the flow path substrate. Also in this case, it is possible to perform position adjustment with precision between the flow path substrate U1 and the protection substrate 70 by making the alignment mark M2 match the positioning hole M3. The sealing plate 40 shown in FIG. 11A can also serve as the coupling substrate U2; however, even if a positioning hole is not provided in the sealing plate 40, the flow path substrate U1 and the protection substrate 70 constitute the flow path unit U0.

The first positioning mark may not be provided at the inside of the flow path substrate, but provided at the first substrate-surface side of the flow path substrate.

FIG. 11B illustrates a liquid ejecting head 1B in which the alignment space M1 is provided at the first substrate-surface U11 side of the flow path substrate U1. In the first substrate-surface U11 of the flow path substrate of the liquid ejecting head 1B, the space M1 recessed toward the second substrate-surface U12 is formed being adjusted to the position of the alignment mark M2. Also in this case, if the space M1 is filled with a light blocking liquid and a seal is provided on the first substrate-surface U11, it is possible to form the alignment mark M2 having a planar shape obtained by projecting the space M1 onto the second substrate-surface U12 in the thickness direction D2. This variation has an advantage that it is easy to fill the space M1 with a light blocking liquid because an opening of the space M1 is provided in the first substrate-surface U11.

In addition, the third positioning mark may be such a mark that does not allow light to pass through the coupling substrate, for example, may be a recess being recessed from the surface and not penetrating through the substrate, a different material, or the like. Even with these third positioning marks, the positions of the substrates can be adjusted by making use of reflection light from the flow path substrate U1 side even if the third positioning mark does not transmit light.

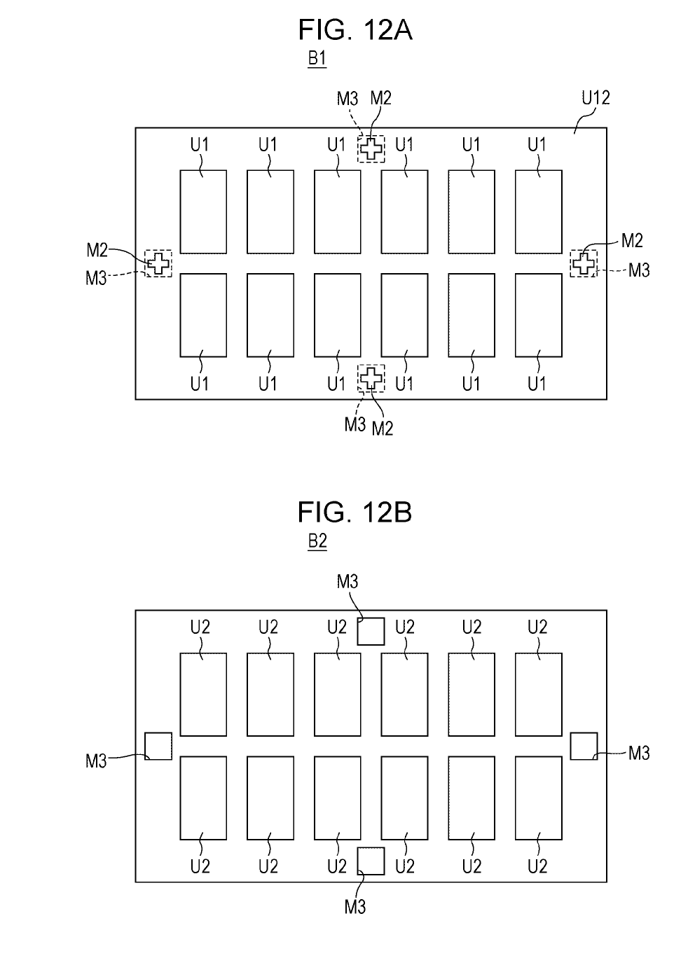

The position adjustment technique of this invention can be applied to position adjustment between a large B1-size substrate of the flow path substrates U1 as shown in FIG. 12A and a large B2-size substrate of the coupling substrates U2 as shown in FIG. 12B. The large B1-size substrate shown in FIG. 12A is a substrate in which a plurality of flow path substrates U1 are formed and the alignment marks M2 are formed in the vicinity of each of the four sides. Needless to say, each alignment mark M2 is provided at a position where each of the alignment spaces is projected. The large B2-size substrate shown in FIG. 12B is a substrate in which a plurality of coupling substrates U2 are formed and the positioning holes M3 are formed in the vicinity of each of the four sides. In this case, by making the alignment marks M2 match the positioning holes M3, it is possible to perform position adjustment with precision between the large B1-size substrate and the large B2-size substrate so as to provide a large-sized flow path unit. Thereafter, if the combinations of the flow path substrates U1 and the coupling substrates U2 are each taken out as a flow path unit, this flow path unit can be used in the liquid ejecting head or the like.

It is preferable for the number of combinations of the first, second and third positioning marks to be two or more; however, only one combination thereof may be acceptable. Also in this case, the deviation in position caused by a slight variation in the contraction rate at the time of forming the flow path substrate by heating the precursor is reflected to the second positioning mark, and visibility of the second positioning mark is excellent when viewed from the second substrate-surface. Accordingly, the positions of the substrates can be precisely adjusted.

Note that the heating of the precursor to form the flow path substrate includes, in addition to the calcination mentioned earlier, heating at temperatures at which the precursor is dried or hardened by a chemical reaction, heating at temperatures at which a plurality of thermocompressively bondable precursors are connected with each other, and so on.

### 6. CONCLUSION

As described thus far, according to the invention, techniques and the like capable of enhancing the precision of position adjustment between a flow path substrate and a coupling substrate can be provided in various modes. It is needless to say that it is possible to obtain the above-described principal actions and effects with a technique or the like that includes only the constituent elements of an independent aspect of the invention and does not include the constituent elements of dependent aspects of the invention.

Further, it is possible to implement a configuration in which the constituent elements disclosed in the above embodiment and variations are replaced with each other or the combinations of the constituent elements are changed, a configuration in which the constituent elements disclosed in the known techniques and the above embodiment and variations are replaced with each other or the combinations of the constituent elements are changed, and so on. It is to be noted that those configurations are also included in this invention.

The entire disclosure of Japanese Patent Application No. 2013-048332, filed Mar. 11, 2013 is incorporated by reference herein.

What is claimed is:

1. A flow path unit comprising:
a light transmitting flow path substrate having a liquid flow path,
a space as a first positioning mark that is provided at a side of a first substrate-surface of the light transmitting flow path substrate or at an inside of the light transmitting flow path substrate,
a film as a second positioning mark that is provided at a side of a second substrate-surface of the light transmitting flow path substrate that is opposite to the side of the first substrate-surface,
a coupling substrate connected with the flow path substrate, and
a hole as a third positioning mark is provided in the coupling substrate,
wherein the second positioning mark is provided at a position where the first positioning mark is projected.

2. The flow path unit according to claim 1,
wherein the flow path substrate does not have the liquid flow path at a position between the first positioning mark and the second positioning mark.

3. The flow path unit according to claim 1,
wherein the second positioning mark at least contains the same material as a material of an electrode provided at the second substrate-surface side of the flow path substrate.

4. The flow path unit according to claim 1,
wherein the first positioning mark is provided inside the flow path substrate, and
the flow path substrate has a communication hole extending from the first positioning mark to the first substrate-surface.

5. The flow path unit according to claim 1,
wherein a plurality of the liquid flow paths are provided in the flow path substrate, the second positioning marks and the third positioning marks are respectively disposed at both sides of the plurality of liquid flow paths, and
the flow path substrate and the coupling substrate are connected with each other so that a position of the second positioning mark corresponding to the third positioning mark at one side of both the sides of the plurality of liquid flow paths and a position of the second positioning mark corresponding to the third positioning mark at the other side have a symmetric positional relationship with respect to the plurality of liquid flow paths.

6. A liquid ejecting head comprising:
the flow path unit according to claim 1; and
a nozzle communicating with the liquid flow path.

7. A liquid ejecting head comprising:
the flow path unit according to claim 2; and
a nozzle communicating with the liquid flow path.

8. A liquid ejecting head comprising:
the flow path unit according to claim 3; and
a nozzle communicating with the liquid flow path.

9. A liquid ejecting head comprising:
the flow path unit according to claim 4; and
a nozzle communicating with the liquid flow path.

10. A liquid ejecting head comprising:
the flow path unit according to claim 5; and
a nozzle communicating with the liquid flow path.

11. A liquid ejecting apparatus comprising:
the liquid ejecting head according to claim 6.

12. A liquid ejecting apparatus comprising:
the liquid ejecting head according to claim 7.

13. A liquid ejecting apparatus comprising:
the liquid ejecting head according to claim 8.

14. A liquid ejecting apparatus comprising:
the liquid ejecting head according to claim 9.

15. A liquid ejecting apparatus comprising:
the liquid ejecting head according to claim 10.

16. A manufacturing method of a light transmitting flow path substrate provided with a liquid flow path and connected with a coupling substrate in which a positioning mark is provided, the manufacturing method of the flow path substrate comprising:
forming a first mark in which a first positioning mark is formed at the side of a first substrate-surface of a precursor of a flow path substrate base or at the inside of the precursor;
forming the flow path substrate base by heating the precursor; and
forming a second mark in which a second positioning mark is formed at a position where the first positioning mark is projected at the side of a second substrate-surface of the flow path substrate base that is opposite to the side of the first substrate-surface.
